(19) United States
(12) Patent Application Publication
(10) Pub. No.: US 2025/0187018 A1
(43) Pub. Date: Jun. 12, 2025

(54) MILLING SYSTEMS AND METHODS FOR PRODUCING MATERIALS WITH A PARTICULAR PARTICLE SIZE DISTRIBUTION

(71) Applicant: SUNCOKE TECHNOLOGY AND DEVELOPMENT LLC, Lisle, IL (US)

(72) Inventors: John Francis QUANCI, Haddonfield, NJ (US); Daniel C. Charles, Lisle, IL (US)

(21) Appl. No.: 18/972,005

(22) Filed: Dec. 6, 2024

Related U.S. Application Data
(60) Provisional application No. 63/606,725, filed on Dec. 6, 2023.

(51) Int. Cl. B02C 15/00; B02C 23/08

(52) U.S. Cl. CPC B02C 15/00; B02C 23/08; B02C 2015/002; B02C 2201/00

(57) ABSTRACT

Milling systems and methods for producing materials with a particular particle size distribution are disclosed herein. In some embodiments, a system for providing materials having a particular particle size includes a mill configured to produce grinded materials, a classifier positioned to receive the grinded materials and including a first classifier outlet and a second classifier outlet, and a screen positioned to receive the grinded materials from the second classifier outlet and including a first screen outlet and a second screen outlet. The classifier can be configured to separate the grinded materials based on a first threshold particle size. The screen can be configured to separate the grinded materials based on a second threshold particle size greater than the first threshold particle size.

### CROSS-REFERENCE TO RELATED APPLICATION(S)

The present application claims the benefit of U.S. Provisional Patent Application No. 63/606,725, filed Dec. 6, 2023, the disclosure of which is incorporated herein by reference in its entirety.

### TECHNICAL FIELD

This present disclosure relates to systems and methods for producing industrial materials with a desired particle size distribution. Some embodiments relate to systems and methods for producing coke-related materials with a desired particle size distribution.

### BACKGROUND

The coking process produces coke products of various sizes in different fractions. Conventionally, coke products are classified based on size, with foundry coke having a size of four inches or more, egg (industrial coke) having a size of two to four inches, stove having a size of one to two inches or one to one and one-half inches, nut having a size of one-half to one inch, and carbonaceous backfill having a size less than one-half inch. After production, the coke products can be ground to smaller particle sizes and separated into different particle size fractions by a mill. Mills, however, are typically operated based on only a particular minimum size that all particles must be beneath. Moreover, mills are often limited in the particle size they can produce, and depending on the desired particle size, can produce particles that are either too coarse or too fine, but not within a particular particle size distribution. As such, the typical mill or mill system is unable to produce an industrial product that has a particular particle size distribution that is neither too coarse nor too fine. Additionally, mills can create issues with material handling and may not be continuous, thereby decreasing overall product yield. As such, there exists a need to produce an industrial product having a particular particle size distribution in an automated or semi-automated manner that can improve overall yield.

### BRIEF DESCRIPTION OF THE DRAWINGS

Features, aspects, and advantages of the presently disclosed technology may be better understood with regard to the following drawings.

FIG. 1 is a diagram illustrating an industrial system in accordance with embodiments of the present technology.

FIG. 2 is a flow diagram illustrating a method of separating materials in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

Embodiments of the present disclosure relate to systems and methods for producing industrial materials, such as a carbonaceous backfill, having a particular particle size (e.g., a particle size range or distribution). The particular particle size can be tailored based on industrial needs and/or specific usage applications. For example, in embodiments of the present technology, the particular particle size can be between 150 micrometers and 300 micrometers, or 180 micrometers and 250 micrometers. In another example, the particular particle size can be between 50 millimeters and 200 millimeters. Furthermore, the present technology provides high yields of the carbonaceous backfill material by, e.g., removing materials having a particle size outside the desired particle size distribution by a combination of a classifier, mill, and other components.

Embodiments of the present disclosure can comprise a system including a mill, a classifier, and a screen. The mill is configured to produce grinded materials, and the classifier is positioned to separate the grinded materials based on a first threshold particle size. The separation is performed such that the grinded materials having at least the first threshold particle size are directed toward a second classifier outlet of the classifier. The screen is positioned to receive the grinded materials from the second classifier outlet, and includes a first screen outlet and a second screen outlet. The screen can separate the grinded materials based on a second threshold particle size such that (i) the grinded materials having at least the second threshold particle size are directed to the mill via the second screen outlet, and (ii) the grinded materials not directed to the mill have a particle size between the first threshold particle size and the second threshold particle size.

Embodiments of the present disclosure can also include a method of producing materials having a particular particle size distribution. The method includes producing grinded materials via a mill (e.g., a rod mill), and separating the grinded materials based on a first threshold particle size via a classifier. Separating the grinded materials can include directing the grinded materials having a particle size below a first threshold particle size toward a first classifier outlet, and directing the grinded materials having a particle size of at least the first threshold particle size toward a second classifier outlet. The method further includes separating the grinded materials received from the second classifier outlet based on a second threshold particle size via a screen that includes a first screen outlet and a second screen outlet. The separation via the screen includes directing the grinded materials having at least the second threshold particle size to the mill via the second screen outlet. The grinded materials having a particle size less than the second threshold particle size have a particle size between the first threshold particle size and the second threshold particle size. The second threshold particle size is greater than the first threshold particle size.

In the figures, identical or similar reference numbers identify generally similar, and/or identical, elements. Many of the details, dimensions, and other features shown in the figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Systems and Methods for Particle Size Separation of Industrial Materials

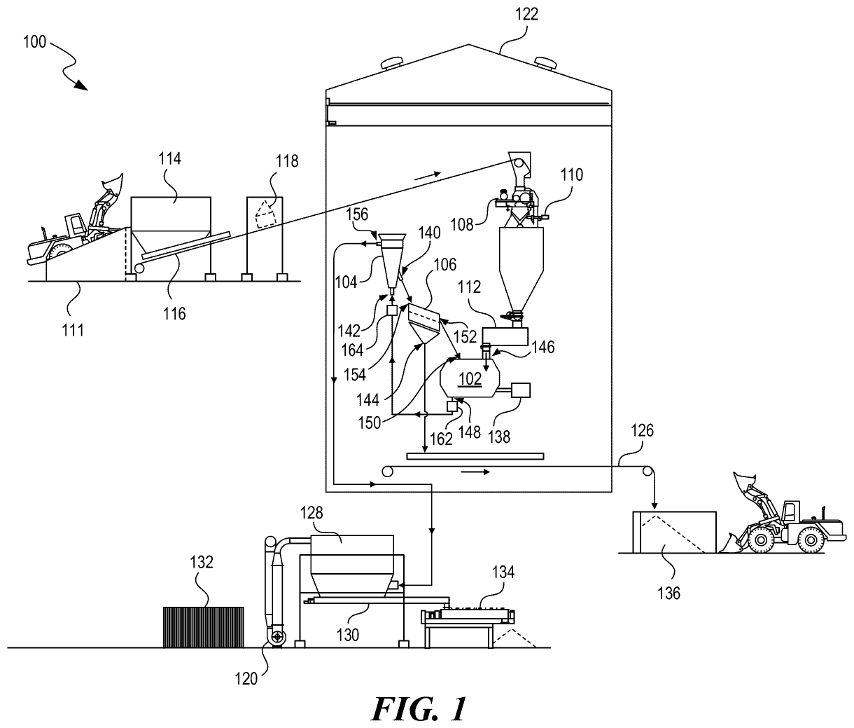

FIG. 1 is a diagram illustrating a system 100 configured to produce industrial materials having a particular particle size range, in accordance with embodiments of the present technology. The system 100 includes a mill 102, a classifier 104, and a screen 106, optionally located within a housing 122. The system 100 can further include a crusher 108, a flop gate actuator 110, a feeder 112, and a mill heater unit 138. The system 100 can further include, or be in connection with, a feed hopper unit 114, a feed conveyor unit 116, a feed hopper retaining wall unit 111, a belt magnet unit 118, a baghouse 128, a product screw conveyor unit 130, a transport air fan unit 120, a pug mill 134, a motor control center unit 132, a product conveyor unit 126, and a product bunker unit 136.

The feed hopper unit 114 can be positioned to receive feed materials, and can be coupled to a feed hopper retaining wall unit 111. In some embodiments, the feed hopper unit 114 includes a holding bin with an integrated tray that receives the starting material and directs it away from the feed hopper unit 114 to the crusher 108 via a feed conveyor unit 116. The feed conveyor unit 116 can include a belt conveyor, a screw conveyor, a chain conveyor, or any other conveyor mechanism suitable for transporting industrial materials. In some embodiments, the feed conveyor unit 116 includes a belt magnet conveyor coupled with the belt magnet unit 118 configured to control the transportation of the starting materials on a conveyor belt.

The crusher 108 can be configured to receive the starting material from the feed hopper unit 114. The starting material can have a particle size of up to 40 millimeter, up to 50 millimeters, or up to 60 millimeters. The crusher 108 can be configured to crush or otherwise reduce the size of the starting material to have a particle size of up to 10 millimeters, up to 15 millimeters, or up to 20 millimeters. The mill 102 includes a first mill inlet 146, a second mill inlet 150, and a mill outlet 148. The mill 102 can be configured to receive the crushed materials from the crusher 108 via the feeder 112. As shown in FIG. 1, the crusher 108 can be positioned at least partially higher (or at least partially above) than the mill 102 so that the crushed materials from the crusher 108 can be transferred to the mill 102 via the feeder 112 at least partially by gravity. In some embodiments, the crushed materials from the crusher 108 are dried (e.g., via ambient drying, heating) before being transferred to the mill 102.

The mill 102 can be configured to grind the crushed material received from the crusher 108, and can be a rod mill, a tumbling mill, a roller mill, a pulverizing mill, a hammer mill, a pin mill, a turbo mill, or any other type of grinding mill. The grinding speed of the mill 102 can be controlled (e.g., by the motor control center unit 132). The grinding speed can affect the particle size distribution of the grinded materials. For example, increasing the grinding speed of a rod mill can decrease the particle size of the grinded materials, and decreasing the grinding speed can increase the particle size of the grinded materials. In embodiments in which the mill 102 includes a rod mill, the number, arrangement, and/or size of rods charged in the rod mill can also affect the grinded materials' particle size. For example, a higher number of rods can result in a smaller particle size of the grinded material.

The feeder 112 can be configured to control the feed rate of the materials flowing from the crusher 108 to the mill 102. For example, feeding the crushed material into the mill 102 with a slower speed rate can cause the mill 102 to produce a powder having a finer particle size and vice versa. In some embodiments, the temperature of the mill 102 is controlled by the mill heater unit 138 (e.g., to control the moisture of the materials while grinding). The grinded materials exiting the mill 102 can have a particle size distribution such that up to 3%, up to 5%, up to 8%, or up to 10% of the grinded materials have a particle size below 100 micrometers or 250 micrometers. In some embodiments, at least 70%, at least 75%, at least 80%, at least 85%, or at least 90% of the grinded materials have a particle size of about 100 micrometers, 150 micrometers, 200 micrometers, 250 micrometers, or 300 micrometers.

The mill 102 can be configured to provide the grinded materials to the classifier 104 via the mill outlet 148. The grinded materials can be transferred to the classifier 104 via a conveyor. In some embodiments, the system 100 further includes a first heating unit 162 and/or a second heating unit 164 downstream of the mill outlet 148. More specifically, the first heating unit 162 can be positioned closer to the mill 102, and the second heating unit 164 can be positioned closer to the classifier 104. The first heating unit 162 and/or the second heating unit 164 can be operable to provide heated air (e.g., at 250° F., 300° F., 350° F., or between 250-350° F.) or other heating mechanism to heat the grinded materials exiting the mill 102 prior to being transferred to the classifier 104. Heating the grinded materials can reduce the moisture content of the grinded materials, thereby reducing clumps and associated clogging further downstream.

As shown in FIG. 1, the classifier 104 can be positioned at least partially higher than the mill 102. The classifier 104 can include a classifier inlet 142 positioned at a bottom region of the classifier 104, a first classifier outlet 156 positioned at a top region of the classifier 104, and a second classifier outlet 140 positioned between the classifier inlet 142 and the first classifier outlet 156. The classifier 104 can be configured to separate the grinded materials into different portions based on a particle size threshold. In some embodiments, the classifier 104 is an air classifier (e.g., a wheel classifier) configured to separate materials based on the size, shape, and/or density of the materials. The classifier 104 can include a separation column with an air drag configured to sort materials vertically so that lighter weight and/or smaller particle size materials are dragged toward the top region of the column (e.g., toward the first classifier outlet 156) while heavier weight and/or larger particle size materials are dragged toward lower regions of the column (e.g., toward the second classifier outlet 140). In some embodiments, the classifier 104 includes one or more classifier wheels so that air is dragged through the one or more classifier wheels. The one or more classifier wheels can reject particles having a particle size above a particular threshold size and direct them toward the bottom region of the column (e.g., toward the second classifier outlet 140). The portion of the materials having a particle size below the particular threshold size can be dragged through the classifier wheel toward the top region of the column (e.g., toward the first classifier outlet 156).

The classifier 104 can be configured to separate the grinded materials based on a first threshold particle size. In some embodiments, the first threshold particle size can correspond to a mesh size of 60 to 150 (e.g., corresponding to particle sizes of 105 micrometers to 250 micrometers). For example, the first threshold particle size can correspond to a mesh size of 60, 80, 100, or 150. The classifier 104 can thereby separate the grinded materials received from the mill 102 so that a first portion of the grinded materials having a particle size below 105 micrometers to 250 micrometers is directed toward the first classifier outlet 156 and a second portion of the grinded materials having a particle size below the first threshold particle size is directed toward the second classifier outlet 140 (e.g., material having a particle size above 105 micrometers to 250 micrometers). For example, the classifier 104 can be configured to separate materials based on a first threshold particle size of mesh 100 (e.g., corresponding to particle size 150 micrometers). A first portion of the material having a particle size below 150 micrometers can be directed toward the first classifier outlet 156 and a second portion of the material having a particle size above 150 micrometers can be directed toward the second classifier outlet 140.

The first portion of the material exiting the classifier 104 via the first classifier outlet 156 (i.e., the material having a particle size below the first threshold particle size) can be transferred to the baghouse 128. The first portion of the material can be further transferred to the pug mill 134 via the product screw conveyor unit 130 (e.g., with the assistance of an air stream by the transport air fan unit 120). The pug mill 134 can be configured to combine the first portion of the material having a particle size below the first threshold particle size with a liquid (e.g., for storage and/or transportation).

The second portion of the material exiting the classifier 104 via the second classifier outlet 140 (i.e., the material having a particle size above the first threshold particle size) can be transferred to the screen 106 through a screen inlet 154. The screen 106 can be configured to separate the second portion of the material received from the classifier 104 into further sub-portions based on a second threshold particle size. The second threshold particle size can be greater than the first threshold particle size associated with the classifier 104. For example, the screen 106 can include a mesh size of 6 to 12 (e.g., mesh size of 6, 8, 10, or 12) corresponding to particle sizes of 3.35 millimeters to 1.4 millimeters. The screen 106 can be configured to direct a first sub-portion of the material having a particle size above the second threshold particle size back to the mill 102 for further grinding through a first screen outlet 152. The mill 102 can receive the first sub-portion of the material having the particle size above the second threshold particle size through the second mill inlet 150. The screen 106 can also be configured to direct a second sub-portion of the material having a particle size below the second threshold particle size but above the first threshold particle size (e.g., an end-product material) to the conveyor unit 126 via a second screen outlet 144. The conveyor unit 126 can be configured to transfer the second sub-portion of the material to the bunker unit 136. As shown, the classifier 104 can be positioned at least partially higher than the screen 106 so that the materials exiting the classifier 104 via the second classifier outlet 140 are transferred to the screen inlet 154 at least partially by gravity. Also, the screen 106 can be positioned at least partially higher than the mill 102 so that the materials exiting the screen 106 via the first screen outlet 152 are transferred to the second mill inlet 150 at least partially by gravity.

The end-product material (e.g., the second sub-portion of the material) collected at the bunker unit 136 can therefore have a particle size between the first and second threshold particle sizes. For example, the particle size of the end-product material can be above 105 micrometers to 300 micrometers (e.g., mesh sizes 50 to 140) and below 1.4 millimeters to 3 millimeters (e.g., mesh sizes 6 to 14). In some embodiments, the system 100 is configured to provide at least 70%, at least 75%, at least 80%, at least 85%, or at least 90% yield for the end-product material having the particle size between the first threshold particle size and the second threshold particle size. For example, at least 70%, at least 75%, at least 80%, at least 85%, or at least 90% of the end product material can have a particle size of 180 micrometers to 250 micrometers (e.g., mesh size 60 to 80).

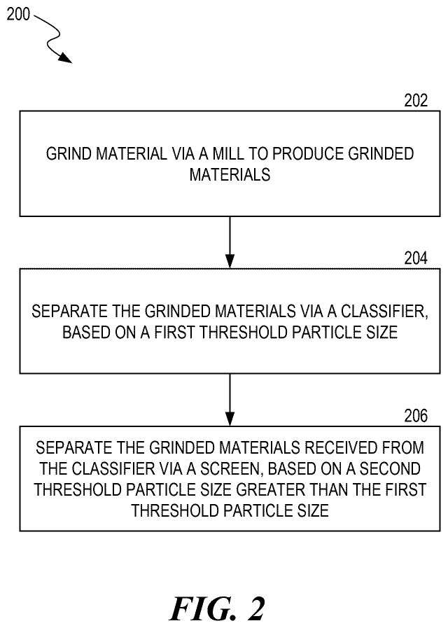

It is appreciated that the dimensions described herein are merely examples, and that the system 100 can be used to obtain materials having other desired particle size target ranges. For example, the classifier 104 and/or the screen 106 can be modified or replaced to adjust the first threshold particle size and/or the second threshold particle size as desired. Therefore, in some embodiments, the system 100 can be operated to output foundry coke (e.g., end-product material having a size between 50 and 200 millimeters. Furthermore, it is appreciated that the system 100 can be operated to process and/or output biochar, pellets, blends, and/or the like. FIG. 2 is a flow diagram illustrating a method 200 of separating materials in accordance with embodiments of the present technology. The method 200 can be performed by a mill system (e.g., the system 100 described with respect to FIG. 1). The system can include a mill (e.g., the mill 102 in FIG. 1), a classifier (e.g., the classifier 104 in FIG. 1), and a screen (e.g., the screen 106 in FIG. 1). In some embodiments, the system includes a crusher (e.g., the crusher 108 in FIG. 1) positioned upstream of the mill. The crusher can provide the materials to the mill for grinding. For example, the system includes a feeder (e.g., the feeder 112 in FIG. 1) between the crusher and the mill. The feeder can feed (or direct) the materials from the crusher to the mill. As shown in FIG. 1, the mill can be positioned at least at a lower vertical position than the crusher. Thereby, the materials are transferred from the crusher to the mill at least partially by gravity.

The method 200 includes grinding material via a mill to produce grinded materials (e.g., starting materials) (process portion 202). In some embodiments, the mill is a rod mill and the materials can include carbonaceous materials and/or coke products. The materials received by the mill from the crusher can have a particle size of up to 10 millimeters, up to 15 millimeters, or up to 20 millimeters. After grinding via the mill, the particle size can be reduced so that more than 65%, more than 75%, or more than 85% of the grinded materials have a particle size of 50 micrometers to 500 micrometers, 100 micrometers to 400 micrometers, 150 micrometers to 300 micrometers, or 100 micrometers to 250 micrometers.

In some embodiments, the system controls a feed rate for providing the materials to the mill from the crusher. The feed rate can be controlled by the feeder. A higher feed rate can result in a greater particle size of the grinded materials while a lower feed rate can result in a smaller particle size. For example, the feed rate can be between 1 ton per hour (tph) and 20 tph, between 3 tph and 15 tph, or between 5 tph and 10 tph. In some embodiments, the system controls a grinding speed of the mill (also referred to as mill speed). Increasing the grinding speed can decrease a particle size for the grinded materials. For example, the grinding speed can be between 20 revolutions per minute (rpm) and 30 rpm, between 22 rpm and 27 rpm, or between 24 rpm and 25 rpm. The rod charge of the mill can be adjusted between 11.8 and 14 tons of charge. The temperature of the mill can be controlled by a mill heater unit (e.g., the mill heater unit 138) in order to control the moisture of the materials while grinding. The moisture can be adjusted to be between 3% and 15%, between 5% and 12%, or between 7% and 10%.

The particle size or a particle size distribution of the grinded materials can be determined by collecting samples of the grinded materials produced by the system and analyzing them, for example, by a sieve shaker (e.g., Humboldt H-4325 sieve shaker). The moisture of the collected samples can be analyzed by a moisture analysis system (e.g., Ohaus Moisture Balance).

In some embodiments, the system includes a feed hopper (e.g., the feed hopper unit 114 connected to the crusher 108 by the feed conveyor unit 116 in FIG. 1). The feed hopper can feed the materials from their original storage to the mill via the crusher and the feeder.

In some embodiments, the method 200 further includes heating and drying the grinded materials from the mill (e.g., using the first heating unit 162 and/or the second heating unit 164 of FIG. 1). Heating and drying can include providing heated air (e.g., at 250° F., 300° F., 350° F., or between 250-350° F.) or other heating mechanism to the grinded materials. Heating and drying the grinded materials can reduce clumps and associated clogging further downstream.

The method 200 further includes separating the grinded materials via a classifier based on a first threshold particle size (process portion 204). The classifier includes a first classifier outlet (e.g., the first classifier outlet 156 in the top portion of the classifier 104 in FIG. 1) and a second classifier outlet (e.g., the second classifier outlet 140 in FIG. 1). Separation via the classifier includes directing the grinded materials having a particle size below a first threshold particle size toward a first classifier outlet and directing the grinded materials having a particle size of at least the first threshold particle size toward a second classifier outlet. For example, the classifier can be an air classifier including a separation column and one or more classifier wheels. The classifier can be configured to direct grinded materials having a particle size above the first threshold particle size down while grinded materials having a particle size below the first threshold particle size are dragged toward a top region of the column.

In some embodiments, the first threshold particle size is from 100 micrometers to 500 micrometers, from 100 micrometers to 400 micrometers, from 100 micrometers to 300 micrometers, from 100 micrometers to 250 micrometers, from 150 micrometers to 250 micrometers, or from 150 micrometers to 180 micrometers. The grinded materials directed toward the first classifier outlet can thereby have a particle size below the first threshold particle size and the grinded materials directed toward the second classifier outlet have a particle size above the first particle size. For example, the grinded materials directed toward the first classifier outlet have a particle size below 100 micrometers to 500 micrometers (e.g., below 500 micrometers, below 400 micrometers, below 300 micrometers, below 250 micrometers, below 200 micrometers, below 150 micrometers, or below 100 micrometers). The grinded materials directed toward the second classifier outlet have particle size above 100 micrometers to 500 micrometers (e.g., above 100 micrometers, above 150 micrometers, above 200 micrometers, above 250 micrometers, above 300 micrometers, above 400 micrometers, or above 300 micrometers). In some embodiments, the first threshold particle size is 150 micrometers so that the grinded materials directed toward the first the first classifier outlet have a particle size below 150 micrometers and the grinded materials directed toward the second classifier outlet have a particle size above 150 micrometers.

In some embodiments, the classifier also includes an inlet (e.g., the classifier inlet 142) positioned at a bottom region of the classifier. The classifier can receive the grinded materials from the mill through the inlet and separate the grinded materials according to the first threshold particle size so that the grinded materials with the particle size below the first threshold particle size are directed toward the first classifier outlet and the grinded materials with the particle size above the first threshold particle size are directed toward the second classifier outlet.

In some embodiments, the system includes a baghouse (e.g., the baghouse 128). The baghouse is positioned to receive the grinded materials having the particle size below the first threshold particle size from the first classifier outlet. The baghouse is configured to store materials having a fine particle size (e.g., fine powders).

In some embodiments, the classifier is positioned at a vertically higher position than the screen. Thus, the grinded materials having at least the first threshold particle size are provided to the screen via the second classifier outlet at least in part by gravity.

The method 200 further includes separating the grinded materials received from the classifier (e.g., the second classifier outlet) via a screen, based on a second threshold particle size. The screen includes a mesh size corresponding to the second threshold particle size, and can be configured to separate the grinded materials based on the mesh size. In some embodiments, the second threshold particle size is 1 millimeter to 100 millimeters, from 1 millimeter to 50 millimeters, or from 1.4 millimeters to 33 millimeters. The screen includes a first screen outlet (e.g., the first screen outlet 152 in FIG. 1) and a second screen outlet (e.g., the second screen outlet 144 in FIG. 1). The separation includes directing the grinded materials having at least the second threshold particle size to the mill via the first screen outlet. The mill can receive the grinded materials having at least the second threshold particle size from the first screen outlet and further grind such materials. The system thereby avoids losses of grinded materials having a particle size that is above the desired particle size distribution. In some embodiments, the grinded materials directed to the mill from the first screen outlet have a particle size greater than 1.4 millimeters (e.g., greater than 1.4 millimeters, greater than 1.7 millimeters, or greater than 2 millimeters). In some embodiments, the grinded materials having at least the second threshold particle size directed to the mill includes 15% to 30% of the materials ground by the mill. The second threshold particle size is greater than the first threshold particle size.

The grinded materials having a particle size less than the second threshold particle size have a particle size between the first threshold particle size and the second threshold particle size. In some embodiments, the screen is configured to provide the grinded materials having the particle size between the first threshold particle size and the second threshold particle size to a product conveyor unit (e.g., the conveyor unit 126 in FIG. 1). For example, separating the grinded materials received from the second classifier outlet via the screen includes directing the grinded materials having the particle size less than the second threshold particle size to a product conveyor unit. The conveyor unit can transfer the grinded materials having the particle size between the first threshold particle size and the second threshold particle size to be stored at a storage unit (e.g., the product bunker unit 136).

In some embodiments, the system is configured to provide at least 70%, at least 75%, at least 80%, at least 85%, or at least 90% yield for the grinded materials having the particle size between the first threshold particle size and the second threshold particle size. In particular, the system is configured to produce high yields of the grinded materials having the particle size between the first and second threshold particle sizes by directing the materials having the particle size above the second threshold particle size back to the mill. This reduces losses by further processing materials having a particle size that is too large. The system can control the yield (e.g., a proportion of the grinded materials directed to the product conveyor unit) by, for example, controlling the feed rate for providing the materials to the mill and/or the grinding speed of the mill.

### III. Conclusion

It will be apparent to those having skill in the art that changes may be made to the details of the above-described embodiments without departing from the underlying principles of the present disclosure. In some cases, well-known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below as numbered clauses (1, 2, 3, etc.) for convenience. These are provided as examples and do not limit the present technology. It is noted that any of the dependent clauses may be combined in any combination and placed into a respective independent clause. The other clauses can be presented in a similar manner.

1. A system for providing materials having a particular particle size, the system comprising:
a mill configured to produce grinded materials;
a classifier positioned to receive the grinded materials and including a first classifier outlet and a second classifier outlet, wherein the classifier is configured to separate the grinded materials based on a first threshold particle size, such that the grinded materials having at least the first threshold particle size are directed toward the second classifier outlet; and
a screen positioned to receive the grinded materials from the second classifier outlet and including a first screen outlet and a second screen outlet, wherein the screen is configured to separate the grinded materials based on a second threshold particle size greater than the first threshold particle size, such that (i) the grinded materials having at least the second threshold particle size are directed to the mill via the second screen outlet and (ii) the grinded materials not directed to the mill have a particle size between the first threshold particle size and the second threshold particle size.

2. The system of any one of the clauses herein, wherein the first threshold particle size is at least 150 micrometers or within a range from 150 micrometers to 200 micrometers.

3. The system of any one of the clauses herein, wherein the second threshold particle size is at least 1.4 millimeters or within a range from 1.4 millimeters to 33 millimeters.

4. The system of any one of the clauses herein, wherein the system is configured to provide at least 70%, at least 75%, at least 80%, at least 85%, or at least 90% yield for the grinded materials having the particle size between the first threshold particle size and the second threshold particle size.

5. The system of any one of the clauses herein, wherein the grinded materials having at least the second threshold particle size directed to the mill include 15% to 30% of the materials ground by the mill.

6. The system of any one of the clauses herein, wherein the screen is configured to provide the grinded materials having the particle size between the first threshold particle size and the second threshold particle size to a product conveyor unit.

7. The system of any one of the clauses herein, wherein the screen includes a mesh size corresponding to the second threshold particle size and the screen is configured to separate the grinded materials based on the mesh size.

8. The system of any one of the clauses herein, wherein the mill is positioned to receive the grinded materials having at least the second threshold particle size from the second screen outlet and configured to further grind the grinded materials having at least the second threshold particle size.

9. The system of any one of the clauses herein, wherein the classifier further comprises an inlet positioned at a bottom region of the classifier, and the classifier is configured to receive the grinded materials from the mill through the inlet.

10. The system of any one of the clauses herein, further comprising a baghouse, wherein the baghouse is positioned to receive the grinded materials having a particle size below the first threshold particle size from the first classifier outlet.

11. The system of any one of the clauses herein, wherein the mill is a rod mill.

12. The system of any one of the clauses herein, further comprising a crusher upstream of the mill, wherein the crusher is positioned to provide the materials to the mill for grinding.

13. The system of any one of the clauses herein, further comprising (i) a crusher upstream of the mill and positioned to provide the materials to the mill for grinding, and (ii) a feeder between the crusher and the mill, wherein the feeder is positioned to direct the materials from the crusher to the mill.

14. The system of any one of the clauses herein, wherein the materials include carbonaceous materials and/or coke products.

15. The system of any one of the clauses herein, further comprising a feed hopper positioned to feed the materials to be processes by the mill.

16. The system of any one of the clauses herein, wherein the grinded materials having at least the first threshold particle size are provided to the screen via the second classifier outlet at least in part by gravity.

17. The system of any one of the clauses herein, wherein the mill is configured to grind the materials having a particle size of up to 10 millimeters, up to 15 millimeters, or up to 20 millimeters to the grinded materials, wherein more than 65%, more than 75%, or more than 85% of the grinded materials have a particle size of 150 micrometers to 300 micrometers.

18. The system of any one of the clauses herein, wherein the grinded materials directed toward the first classifier outlet have a particle size below 100 micrometers to 250 micrometers.

19. The system of any one of the clauses herein, wherein the grinded materials directed toward the second classifier outlet have a particle size above 100 micrometers, 150 micrometers, 200 micrometers, or 250 micrometers.

20. The system of any one of the clauses herein, wherein grinded materials directed to the mill from the second screen outlet have a particle size greater than 1.4 millimeters.

21. A method of producing materials having a particular particle size, the method comprising:
grinding materials via a mill to produce grinded materials;
separating the grinded materials via a classifier based on a first threshold particle size, such that the grinded materials having a particle size below a first threshold particle size are directed toward a first classifier outlet of the classifier and the grinded materials having a particle size of at least the first threshold particle size are directed toward a second classifier outlet of the classifier; and
separating the grinded materials received from the second classifier outlet via a screen based on a second threshold particle size greater than the first threshold particle size, such that (i) the grinded materials having at least the second threshold particle size are directed to the mill via a second screen outlet of the screen and (ii) the grinded materials having a particle size less than the second threshold particle size have a particle size between the first threshold particle size and the second threshold particle size.

22. The method of any one of the clauses herein, further comprising controlling a feed rate for providing the materials to the mill, wherein a higher feed rate results in a greater particle size of the grinded materials.

23. The method of any one of the clauses herein, further comprising controlling a grinding speed of the mill, wherein increasing the grinding speed decreases a particle size for the grinded materials.

24. The method of any one of the clauses herein, wherein separating the grinded materials received from the second classifier outlet comprises directing the grinded materials having the particle size less than the second threshold particle size to a product conveyor unit.

25. The method of any one of the clauses herein, wherein separating the grinded materials received from the second classifier outlet comprises directing the grinded materials having the particle size less than the second threshold particle size to a product conveyor unit, the method further comprising controlling a feed rate for providing the materials to the mill and/or controlling a grinding speed of the mill based on a proportion of the grinded materials directed to the product conveyor unit.

26. A system for providing materials having a particular particle size distribution, the system comprising:
a mill configured to grind materials to produce grinded materials;
a classifier positioned to receive the grinded materials and including a first classifier outlet and a second classifier outlet, wherein the classifier is configured to separate the grinded materials based on a first threshold particle size, such that the grinded materials having at least the first threshold particle size are directed toward the second classifier outlet; and
a screen positioned below the classifier, wherein:
   the grinded materials are directed from the second classifier outlet to the screen at least in part by gravity,
   the screen includes a first screen outlet and a second screen outlet,
   the screen is configured to separate the grinded materials based on a second threshold particle size greater than the first threshold particle size, such that (i) the grinded materials having at least the second threshold particle size are directed to the mill via the second screen outlet and (ii) the grinded materials having a particle size less than the second threshold particle size have a particle size between the first threshold particle size and the second threshold particle size, and
   the mill is positioned below the screen such that the grinded materials having at least the second threshold particle size are directed to the mill via the second screen outlet at least partially by gravity.

27. The system of any one of the clauses herein, wherein the first threshold particle size is from 150 micrometers to 200 micrometers.

28. The system of any one of the clauses herein, wherein the second threshold particle size is from 1.4 millimeters to 33 millimeters.

29 The system of any one of the clauses herein, wherein system is configured to provide at least 70%, at least 75%, at least 80%, at least 85%, or at least 90% yield for the grinded materials having the particle size between the first threshold particle size and the second threshold particle size.

30 The system of any one of the clauses herein, wherein the grinded materials having at least the second threshold particle size directed to the mill includes 15% to 30% of the materials ground by the mill.

31. The system of any one of the clauses herein, wherein the screen is configured to provide the grinded materials having the particle size between the first threshold particle size and the second threshold particle size to a product conveyor unit.

32. The system of any one of the clauses herein, wherein the screen includes a mesh size corresponding to the second threshold particle size and the screen is configured to separate the grinded materials based on the mesh size.

33. The system of any one of the clauses herein, wherein the mill is positioned to receive the grinded materials having at least the second threshold particle size from the second screen outlet and configured to further grind the grinded materials having at least the second threshold particle size.

34. The system of any one of the clauses herein, wherein the classifier further comprises an inlet positioned at a bottom region of the classifier, and the classifier is configured to receive the grinded materials through the inlet.

35. The system of any one of the clauses herein, further comprising a baghouse, wherein the baghouse is positioned to receive the grinded materials having a particle size below the first threshold particle size from the first classifier outlet.

36. The system of any one of the clauses herein, wherein the mill is a rod mill.

37 The system of any one of the clauses herein, further comprising a crusher upstream of the mill, wherein the crusher is positioned to provide the materials to the mill for grinding.

38. The system of clause 37, further comprising a feeder between the crusher and the mill, wherein the feeder is positioned to direct the materials from the crusher to the mill.

39. The system of any one of the clauses herein, wherein the materials include carbonaceous materials and/or coke products.

40. The system of any one of the clauses herein, further comprising a feed hopper positioned to feed the materials to be processes by the mill.

41. The system of any one of the clauses herein, wherein the grinded materials having at least the first threshold particle size are provided to the screen via the second classifier outlet at least in part by gravity.

42. The system of any one of the clauses herein, wherein the mill is configured to grind the materials having a particle size of up to 10 millimeters, up to 15 millimeters, or up to 20 millimeters to the grinded materials, wherein more than 65%, more than 75%, or more than 85% of the grinded materials have a particle size of 150 micrometers to 300 micrometers.

43. The system of any one of the clauses herein, wherein the grinded materials directed toward the first classifier outlet have a particle size below 100 micrometers to 250 micrometers.

44. The system of any one of the clauses herein, wherein the grinded materials directed toward the second classifier outlet have a particle size above 100 micrometers to 250 micrometers.

45. The system of any one of the clauses herein, wherein grinded materials directed to the mill from the second screen outlet have a particle size greater than 1.4 millimeters.

We claim:

1. A system for providing materials having a particular particle size, the system comprising:
a mill configured to produce grinded materials;
a classifier positioned to receive the grinded materials and including a first classifier outlet and a second classifier outlet, wherein the classifier is configured to separate the grinded materials based on a first threshold particle size, such that the grinded materials having at least the first threshold particle size are directed toward the second classifier outlet; and
a screen positioned to receive the grinded materials from the second classifier outlet and including a first screen outlet and a second screen outlet, wherein the screen is configured to separate the grinded materials based on a second threshold particle size greater than the first threshold particle size, such that (i) the grinded materials having at least the second threshold particle size are directed to the mill via the second screen outlet and (ii) the grinded materials not directed to the mill have a particle size between the first threshold particle size and the second threshold particle size.

2. The system of claim 1, wherein the first threshold particle size is at least 150 micrometers.

3. The system of claim 1, wherein the second threshold particle size is at least 1.4 millimeters.

4. The system of claim 1, wherein the system is configured to provide at least 70% yield for the grinded materials having the particle size between the first threshold particle size and the second threshold particle size.

5. The system of claim 1, wherein the grinded materials having at least the second threshold particle size directed to the mill include 15% to 30% of the materials ground by the mill.

6. The system of claim 1, wherein the screen includes a mesh size corresponding to the second threshold particle size and the screen is configured to separate the grinded materials based on the mesh size.

7. The system of claim 1, wherein the mill is positioned to receive the grinded materials having at least the second threshold particle size from the second screen outlet and configured to further grind the grinded materials having at least the second threshold particle size.

8. The system of claim 1, wherein the classifier further comprises an inlet positioned at a bottom region of the classifier, and the classifier is configured to receive the grinded materials from the mill through the inlet.

9. The system of claim 1, further comprising a baghouse, wherein the baghouse is positioned to receive the grinded materials having a particle size below the first threshold particle size from the first classifier outlet.

10. The system of claim 1, further comprising a crusher upstream of the mill, wherein the crusher is positioned to provide the materials to the mill for grinding.

11. The system of claim 1, wherein the materials include carbonaceous materials and/or coke products.

12. The system of claim 1, wherein the grinded materials having at least the first threshold particle size are provided to the screen via the second classifier outlet at least in part by gravity.

13. The system of claim 1, wherein the mill is configured to grind the materials having a particle size of up to 20 millimeters to the grinded materials, wherein more than 65% of the grinded materials have a particle size of 150 micrometers to 300 micrometers.

14. The system of claim 1, wherein grinded materials directed to the mill from the second screen outlet have a particle size greater than 1.4 millimeters.

15. A method of producing materials having a particular particle size, the method comprising:
grinding materials via a mill to produce grinded materials;
separating the grinded materials via a classifier based on a first threshold particle size, such that the grinded materials having a particle size below a first threshold particle size are directed toward a first classifier outlet of the classifier and the grinded materials having a particle size of at least the first threshold particle size are directed toward a second classifier outlet of the classifier; and
separating the grinded materials received from the second classifier outlet via a screen based on a second threshold particle size greater than the first threshold particle size, such that (i) the grinded materials having at least the second threshold particle size are directed to the mill via a second screen outlet of the screen and (ii) the grinded materials having a particle size less than the second threshold particle size have a particle size between the first threshold particle size and the second threshold particle size.

16. The method of claim 15, further comprising controlling a feed rate for providing the materials to the mill, wherein a higher feed rate results in a greater particle size of the grinded materials.

17. The method of claim 15, further comprising controlling a grinding speed of the mill, wherein increasing the grinding speed decreases a particle size for the grinded materials.

18. The method of claim 15, wherein separating the grinded materials received from the second classifier outlet comprises directing the grinded materials having the particle size less than the second threshold particle size to a product conveyor unit.

19. The method of claim 15, wherein separating the grinded materials received from the second classifier outlet comprises directing the grinded materials having the particle size less than the second threshold particle size to a product conveyor unit, the method further comprising controlling a feed rate for providing the materials to the mill and/or controlling a grinding speed of the mill based on a proportion of the grinded materials directed to the product conveyor unit.

20. A system for providing materials having a particular particle size distribution, the system comprising:
a mill configured to grind materials to produce grinded materials;
a classifier positioned to receive the grinded materials and including a first classifier outlet and a second classifier outlet, wherein the classifier is configured to separate the grinded materials based on a first threshold particle size, such that the grinded materials having at least the first threshold particle size are directed toward the second classifier outlet; and
a screen positioned below the classifier, wherein:
the grinded materials are directed from the second classifier outlet to the screen at least in part by gravity,
the screen includes a first screen outlet and a second screen outlet,
the screen is configured to separate the grinded materials based on a second threshold particle size greater than the first threshold particle size, such that (i) the grinded materials having at least the second threshold particle size are directed to the mill via the second screen outlet and (ii) the grinded materials having a particle size less than the second threshold particle size have a particle size between the first threshold particle size and the second threshold particle size, and
the mill is positioned below the screen such that the grinded materials having at least the second threshold particle size are directed to the mill via the second screen outlet at least partially by gravity.
